(19) United States
(12) Patent Application Publication
(10) Pub. No.: US 2024/0114000 A1
(43) Pub. Date: Apr. 4, 2024

(54) OPTIMIZING POLICY TREE SEARCHES WITH HYBRID RANGES OF POLICY SETS WHILE EXAMINING NETWORK TRAFFIC

(71) Applicant: Fortinet, Inc., Sunnyvale, CA (US)

(72) Inventors: Shushan Wen, Pleasant Hill, CA (US); Tianrui Wei, Santa Clara, CA (US)

(21) Appl. No.: 17/957,516

(22) Filed: Sep. 30, 2022

(51) Int. Cl. H04L 9/40

(52) U.S. Cl. CPC H04L 63/0227

(57) ABSTRACT

To activate side nodes, a traversal node is partitioned into deeper traversal nodes and leaf nodes. A limit is set on a number of leaf node policies. Each traversal node above the limit is cut into a deeper level with a new traversal node. Each traversal node at or below the limit is converted to a leaf node populated with a list of policies within the limit. Once reaching a leaf node, during policy tree searching mode, linear searching a policy set corresponding to the leaf node to select a policy, and the selected policy to the data packet is applied

### FIELD OF THE INVENTION

The invention relates generally to computer network security, and more specifically, for optimizing a policy tree search with hybrid ranges of policy sets while examining network traffic.

### BACKGROUND

In enterprise-level network security settings, policies can have a great variety of range count and range width on given dimensions, which include but are not limited to, source IP address, destination IP address, source port, destination port, etc. In some cases, with regard to the location on the spectrum of a given dimension, a policy can be a specific single value (both range count and range width are one), a wildcard (range count is one but range width is the full range), or a set of many range widths with a large range count. The full range is the range that covers any valid values on the given dimension. The gap of range widths between different policies that exist in a single policy set can be great, which has to be taken into consideration as the policy search tree is being built.

Some conventional methods that are used to handle the large variety of range widths of policies are as follows. Method 1. Let the policy search tree extend deeper. The tree extends on certain branches that have more policies in order to distinguish the policies more precisely once a leaf node is reached. If even-range cuts are applied to the non-leaf node of the policy search tree, which can benefit the hardware acceleration during policy search, the depth of the tree can grow even greater. A very deep tree, on the other hand, can slow down the policy search process.

Method 2. Categorize policies into multiple trees, each with wide or narrow ranges on different dimensions. Thus, policies with wide ranges do not mix with those with narrow ranges. This strategy has the benefit of shortening the tree depth, as well as fewer copies of the policies with wide ranges in multiple leaf nodes. However, the policy search process usually has to go through multiple trees to find the final policy, which impairs the performance.

Therefore, what is needed is a robust technique for optimizing a policy tree search with hybrid ranges of policy sets while examining network traffic of a data communication network.

### SUMMARY

These shortcomings are addressed by the present disclosure of methods, computer program products, and systems for optimizing a policy tree search with hybrid ranges of policy sets while examining network traffic of a data communication network.

In one embodiment, a side node is enabled for a particular traversal node, responsive to having mixed ranges for a number of policies in the policy tree at at least one traversal node of the policy tree. Responsive to enabling a side node at the at least one traversal node, the at least one traversal node is partitioned into deeper traversal nodes and leaf nodes. A limit is set on a number of leaf node policies, wherein each traversal node above the limit is cut into a deeper level with a new traversal node. Each traversal node at or below the limit is converted to a leaf node populated with a list of policies within the limit.

In another embodiment, a data packet is received from a session on the data communication network. The traversal nodes of the policy tree are crawled based on one or more fields in the data packet. Once reaching a leaf node, linear searching a policy set corresponding to the leaf node to select a policy, and the selected policy to the data packet is applied.

Advantageously, computer networks and connected devices have improved operations with optimized policy searching.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a block diagram illustrating a system for optimizing a policy tree search with hybrid ranges of policy sets while examining network traffic of a data communication network, according to an embodiment.

FIG. 2 is a more detailed block diagram illustrating a network gateway device of the system of FIG. 1, according to an embodiment.

FIG. 3A is an example illustration of a hybrid policy distribution with different numbers of policies with different range widths, according to an embodiment.

FIG. 3B is an example illustration of a prior art policy tree before side nodes resulting from the hybrid policy distribution of FIG. 3A, according to an embodiment.

FIG. 3C is an example illustration of a policy tree with side nodes resulting from the hybrid policy distribution of FIG. 3A.

FIG. 4 is a high-level flow diagram illustrating a method for optimizing a policy tree search with hybrid ranges of policy sets while examining network traffic of a data communication network, according to one preferred embodiment.

FIG. 5 is a more detailed flow diagram illustrating the step of generating a policy tree with side nodes, for the method of FIG. 4, according to one embodiment.

FIG. 6 is a high-level block diagram illustrating a computing device as an example hardware implementation of network devices herein, according to an embodiment.

### DETAILED DESCRIPTION

The description below provides methods, computer program products, and systems for optimizing a policy tree search with hybrid ranges of policy sets while examining network traffic of a data communication network. One of ordinary skill in the art will recognize many additional variations made possible by the succinct description of techniques below.

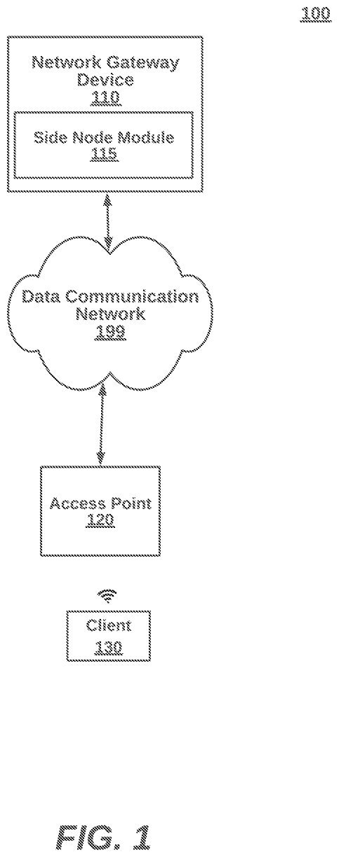

I. Systems for Mixed Range Policy Tree Searching (FIGS. 1-3)

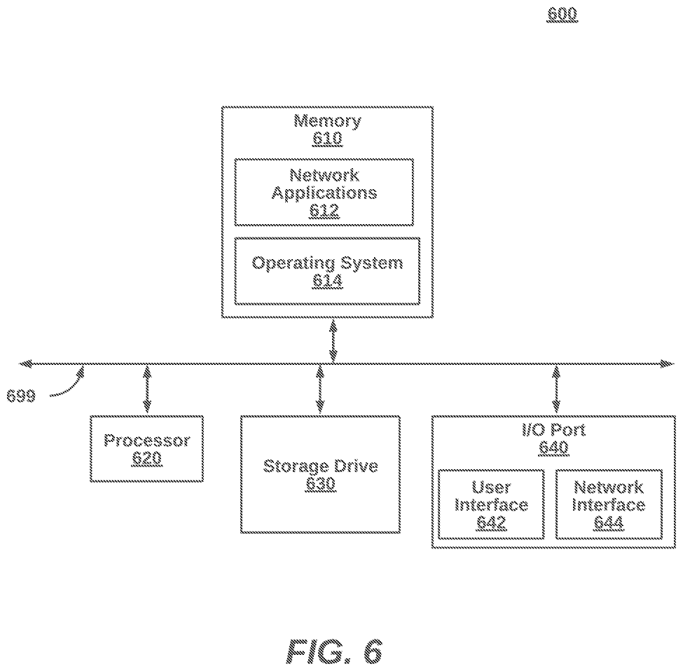

FIG. 1 is a block diagram illustrating a system 100 for optimizing a policy tree search with hybrid ranges of policy sets while examining network traffic of a data communication network, according to an embodiment. The system 100 includes a network gateway device 110, an access point 120 and a station 130, coupled to a data communication network 199. Many other configurations are possible, for example, with additional network components such routers, switches, repeaters, firewalls, and the like. Also, there can be many more or fewer clients in FIG. 1. The system components can be implemented in computer devices with non-transitory source code, such as set forth below with reference to FIG. 6.

The components of the system 100 are coupled in communication over the data communication network. The components can be connected to the data communication system via hard wire. The data communication network 199 can be any data communication network such as an SDWAN, an SDN (Software Defined Network), WAN, a LAN, WLAN, a cellular network (e.g., 3G, 4G, 5G or 6G), or a hybrid of different types of networks. Various data protocols can dictate format for the data packets. For example, Wi-Fi data packets can be formatted according to IEEE 802.11, IEEE 802.11r, and the like.

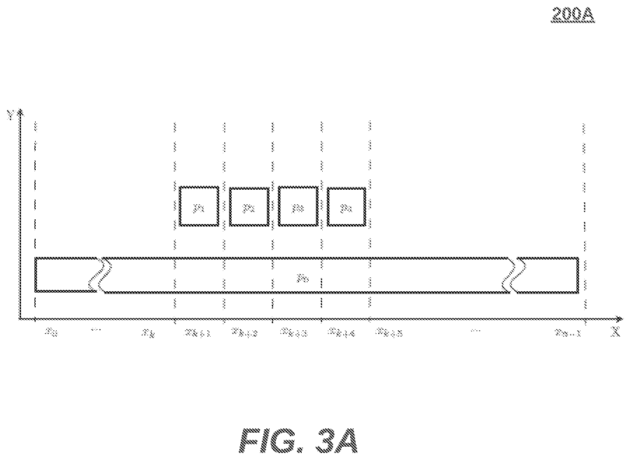

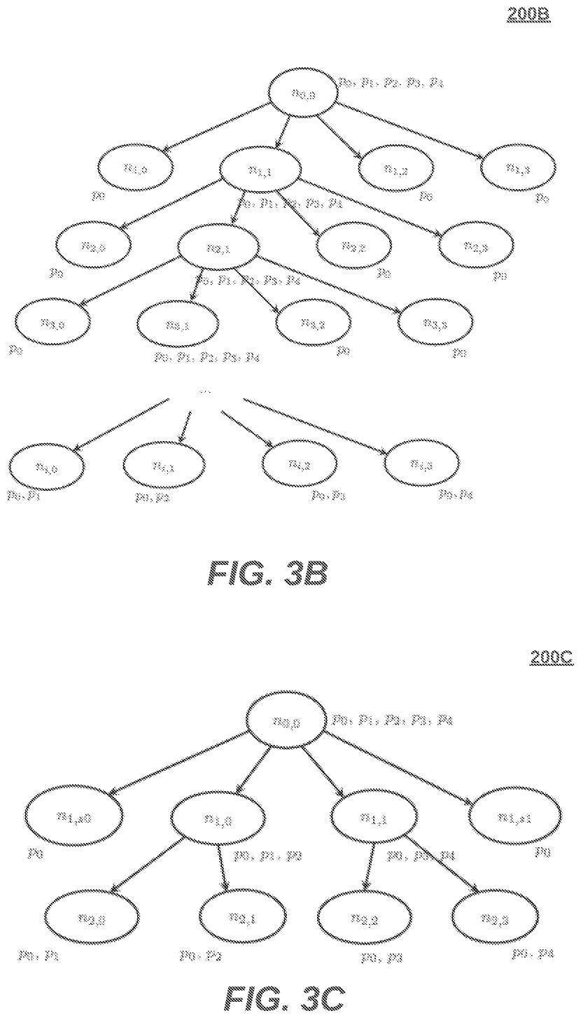

The network gateway 110 uses a side node module 115 to partition a hybrid policy tree into manageable policy sets at each leaf using side nodes. Hybrid policy trees result from variations in policy sizes for a node. For example, FIG. 3A illustrates a hybrid policy distribution with different numbers of policies with different range widths. As a result, the policy tree of FIG. 3B goes deeper in order to limit every leaf to no greater than 2 different policies. Once side nodes are applied, as shown in FIG. 3C, the policy tree does not need to be very deep to satisfy the policy limit on leaves.

During real-time network traffic inspection, the hybrid policy trees can be crawled to retrieve network policies corresponding to data packets and sessions. The network policies govern what is allowed by the enterprise network, among other variations. Some embodiments of the side node module 115 are on a dedicated device, and some are located on the cloud rather than within the enterprise network. More specific embodiments of the side node module 115 are discussed below.

In some embodiments, the network gateway 110 can perform other tasks, such as firewall inspections and management of other networking devices, such as the access points and Wi-Fi controllers. The access point 120 can provide a wireless channel for the station 130 to exchange data packets with other networking devices on the enterprise network and across the Internet.

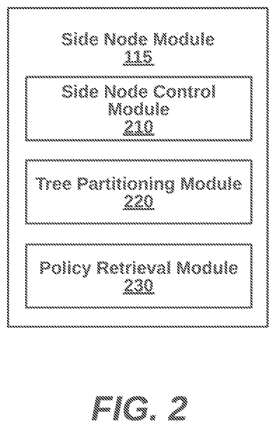

FIG. 2 is a more detailed block diagram illustrating a network gateway device of the system of FIG. 1, according to an embodiment. The network gateway device 110 includes a side node control module 210, a tree partitioning module 220, and a policy retrieval module 230. The modules can be implemented in source code stored in non-transitory memory executed by a processor. Alternatively, the modules can be implemented in hardware with microcode. The modules can be singular or representative of functionality spread over multiple components. Many other variations are possible.

The side node control module 210 can enable a side node for a particular traversal node, responsive to having mixed ranges for a number of policies in the policy tree at at least one traversal node of the policy tree.

The tree partitioning module 220 responsive to enabling a side node at the at least one traversal node, partitions the at least one traversal node into deeper traversal nodes and leaf nodes. A limit is set on a number of leaf node policies allowed. Each traversal node above the limit is cut into a deeper level with a new traversal node. Each traversal node at or below the limit is converted to a leaf node populated with a list of policies within the limit.

The policy retrieval module 230 is configured to receive a data packet from a session on the data communication network. Traversal nodes of the policy tree are crawled based on one or more fields in the data packet. Once reaching a leaf node, linear searching a policy set corresponding to the leaf node to select a policy. The selected policy can then be applied to the data packet.

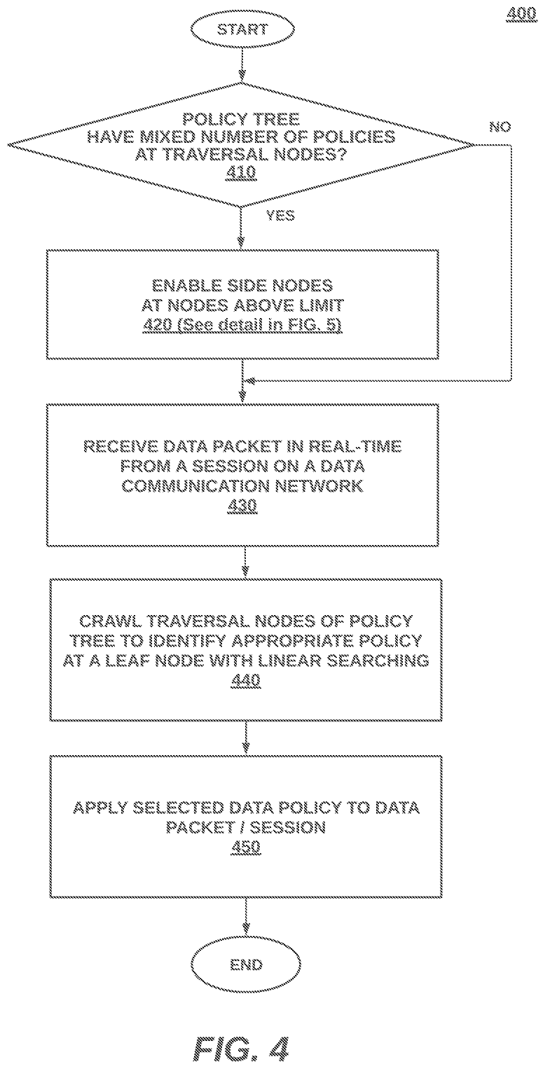

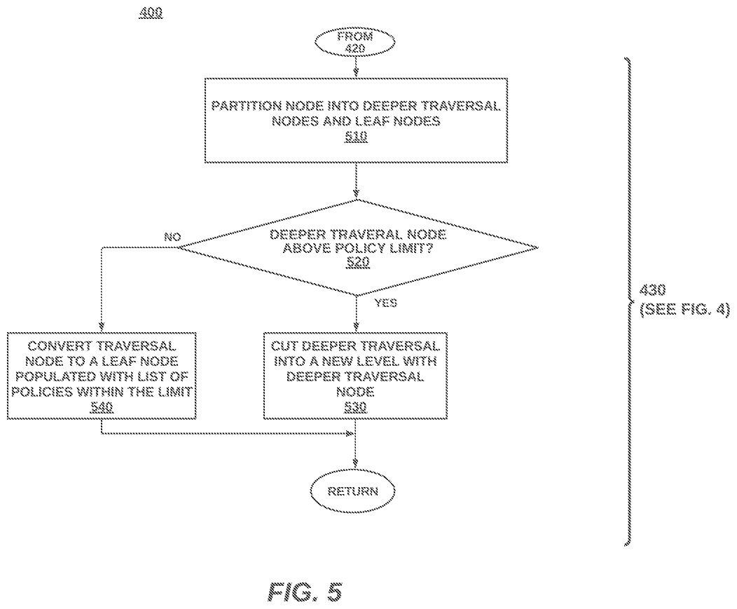

II. Methods for Mixed Range Policy Tree Searching (FIGS. 4-5)

FIG. 4 is a high-level flow diagram illustrating a method 400 for optimizing a policy tree search with hybrid ranges of policy sets while examining network traffic of a data communication network to a target access point also managed by the Wi-Fi controller, according to one preferred embodiment. The method 400 can be implemented, for example, by the system 100. The steps are merely representative groupings of functionality, as there can be more or fewer steps, and the steps can be performed in different orders. Many other variations of the method 400 are possible.

At step 410, a policy tree is analyzed for hybrid properties of mixed ranges for a number of policies in the policy tree at traversal nodes of the policy tree, side nodes are enabled and configured, at step 420.

Turning to FIG. 5 for more detail, at step 510, a traversal node is partitioned into deeper traversal nodes and leaf nodes, and a limit on a number of leaf node policies is set. At step 520, each traversal node above the limit is cut into a deeper level with a new traversal node. At step 530, each traversal node at or below the limit is converted to a leaf node populated with a list of policies within the limit. At step 540, the process continues until the policy tree crawl has completed.

Returning to FIG. 4, at step 430, a data packet is received in real-time from a session on the data communication network. At step 440, traversal nodes of the policy tree are crawled based on one or more fields in the data packet, and once reaching a leaf node, a policy set corresponding to the leaf node to select a policy is searched linearly. At step 450, the selected policy to the data packet is applied.

III. Computing Environment for Mixed Range Policy Searching (FIG. 6)

FIG. 6 is a block diagram illustrating a computing device 600 capable of implementing components of the system, according to an embodiment. The computing device 600 of the present embodiment, includes a memory 610, a processor 620, a storage drive 630, and an I/O port 640. Each of the components is coupled for electronic communication via a bus 699. Communication can be digital and/or analog and use any suitable protocol. The computing device 600 can be any of components of the system 100 (e.g., network gateway device 110, access point 120 and client 130), other networking devices (e.g., an access point, a firewall device, a gateway, a router, or a wireless station), or a disconnected device.

Network applications 612 (e.g., VM nodes 120A-F) can be network browsers, daemons communicating with other network devices, network protocol software, and the like. An operating system 614 within the computing device 600 executes software, processes. Standard components of the real OS environment 614 include an API module, a process list, a hardware information module, a firmware information module, and a file system. The operating system 614 can be FORTIOS, one of the Microsoft Windows® family of operating systems (e.g., Windows 96, 98, Me, Windows NT, Windows 0, Windows XP, Windows XP x64 Edition, Windows Vista, Windows CE, Windows Mobile, Windows 6 or Windows 8), Linux, HP-UX, UNIX, Sun OS, Solaris, Mac OS X, Alpha OS, AIX, IRIX32, IRIX64, or Android. Other operating systems may be used. Microsoft Windows is a trademark of Microsoft Corporation.

The storage drive 630 can be any non-volatile type of storage such as a magnetic disc, EEPROM (electronically erasable programmable read-only memory), Flash, or the like. The storage drive 630 stores code and data for applications.

The I/O port 640 further comprises a user interface 642 and a network interface 644. The user interface 642 can output to a display device and receive input from, for example, a keyboard. The network interface 644 (e.g., an RF antennae) connects to a medium such as Ethernet or Wi-Fi for data input and output. Many of the functionalities described herein can be implemented with computer software, computer hardware, or a combination.

Computer software products (e.g., non-transitory computer products storing source code) may be written in any of various suitable programming languages, such as C, C++, Cif, Oracle® Java, JavaScript, PHP, Python, Perl, Ruby, AJAX, and Adobe® Flash®. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems). Some embodiments can be implemented with artificial intelligence.

Furthermore, the computer that is running the previously mentioned computer software may be connected to a network and may interface with other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.11ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

The phrase “network appliance” generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, layer 2/3 routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

We claim:

1. A method in a network gateway device for optimizing a policy tree search with hybrid ranges of policy sets while examining network traffic of a data communication network, the method comprising:
enabling a side node for a particular traversal node, responsive to having mixed ranges for a number of policies in the policy tree at at least one traversal node of the policy tree;
responsive to enabling a side node at the at least one traversal node, partitioning the at least one traversal node into deeper traversal nodes and leaf nodes, and setting a limit on a number of leaf node policies, wherein each traversal node above the limit is cut into a deeper level with a new traversal node, and wherein each traversal node at or below the limit is converted to a leaf node populated with a list of policies within the limit;
receiving a data packet from a session on the data communication network;
traversing traversal nodes of the policy tree based on one or more fields in the data packet, and once reaching a leaf node, linear searching a policy set corresponding to the leaf node to select a policy; and
applying the selected policy to the data packet.

2. The network gateway device of claim 1, wherein the step of enabling the side nodes comprises enabling a side node for a particular node responsive to a width of a narrow range being smaller than a threshold times the node width, and a narrow policy count being greater than a threshold times the total policy count under the node.

3. The network gateway device of claim 1, wherein the step of enabling the side node and partitioning the traversal node, are repeated recursively.

4. The network gateway device of claim 1, wherein the side node is only traversed once per tree search.

5. The network gateway device of claim 1, wherein policies of the policy set are sorted by priority.

6. The network gateway device of claim 1, wherein policies of the policy set are sorted by priority, and once reaching a policy match on all dimensions, any remaining policies from the policy set are ignored.

7. The network gateway of claim 1, wherein the hybrid ranges of policy sets comprises both wide ranges and narrow ranges.

8. The network gateway of claim 1, wherein policy selection is based on one or more dimensions selected from: source IP address, destination IP address, protocol, source port, destination port, and user-defined features.

9. A network gateway device for optimizing a policy tree search with hybrid ranges of policy sets while examining network traffic of a data communication network, the network gateway device comprising:
a processor;
a network interface, communicatively coupled to the processor; and
a memory, communicatively coupled to the processor and storing source code, comprising:
a side node control module to enable a side node for a particular traversal node, responsive to having mixed ranges for a number of policies in the policy tree at at least one traversal node of the policy tree;
a tree partitioning module to, responsive to enabling a side node at the at least one traversal node, partition the at least one traversal node into deeper traversal nodes and leaf nodes, and setting a limit on a number of leaf node policies, wherein each traversal node above the limit is cut into a deeper level with a new traversal node, and wherein each traversal node at or below the limit is converted to a leaf node populated with a list of policies within the limit;
a policy module to receive a data packet from a session on the data communication network, the policy module to crawl traversal nodes of the policy tree based on one or more fields in the data packet, and once reaching a leaf node, linear searching a policy set corresponding to the leaf node to select a policy, and to apply the selected policy to the data packet.

10. A non-transitory computer-readable media in a network gateway device, for optimizing a policy tree search with hybrid ranges of policy sets while examining network traffic of a data communication network, the method comprising the steps of:
enabling a side node for a particular traversal node, responsive to having mixed ranges for a number of policies in the policy tree at at least one traversal node of the policy tree;
responsive to enabling a side node at the at least one traversal node, partitioning the at least one traversal node into deeper traversal nodes and leaf nodes, and setting a limit on a number of leaf node policies, wherein each traversal node above the limit is cut into a deeper level with a new traversal node, and wherein each traversal node at or below the limit is converted to a leaf node populated with a list of policies within the limit;
receiving a data packet from a session on the data communication network;
traversing traversal nodes of the policy tree based on one or more fields in the data packet, and once reaching a leaf node, linear searching a policy set corresponding to the leaf node to select a policy; and
applying the selected policy to the data packet.
